(19) United States
(12) Patent Application Publication
(10) Pub. No.: US 2025/0052921 A1
(43) Pub. Date: Feb. 13, 2025

(54) DETERMINING THICKNESS OF GLACIAL CHANNELS FROM SEISMIC SURVEYS

(71) Applicant: Saudi Arabian Oil Company, Dhahran (SA)

(72) Inventors: Ahmed Naseem Al-Dawood, Safwa (SA); Mohammed Yousif Aldakheel, Dammam (SA); Ahmed Moustafa AbdelWahab M. Kassem, London (GB); Hamad Mohammed Alghenaim, Dhahran (SA)

(21) Appl. No.: 18/446,599

(22) Filed: Aug. 9, 2023

(51) Int. Cl. G01V 1/30; E21B 44/00; E21B 49/00; G01V 1/34; G06N 20/20

(52) U.S. Cl. CPC G01V 1/307; E21B 49/00; G01V 1/34; G01V 20/00; G06N 20/20; E21B 44/00; E21B 2200/20; G01V 2210/624; G01V 2210/64

(57) ABSTRACT

Systems and methods for drilling a hydrocarbon well in a subterranean formation based on channel thicknesses are configured for receiving seismic data for the subterranean formation; extracting values for seismic attributes from the seismic data; executing a machine learning model trained using synthetic seismic attribute values that are associated with true values of channel thicknesses for synthetic channels, the machine learning model receiving the extracted values for the seismic attributes as input values; generating, based on the executing, at least one predicted value of a channel thickness for a channel in the subterranean formation; generating, based on the at least one predicted value of the channel thickness for the channel, a map of the subterranean formation including the channel.

### TECHNICAL FIELD

This specification relates generally to geophysical exploration, and more particularly to seismic surveying and processing of seismic data.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays a vital role in hydrocarbon exploration and is one key step in the interpretation of seismic data for reservoir characterization. The seismic facies in a geological area can provide useful information, particularly about the types of sedimentary deposits and the anticipated lithology.

In reflection seismology, geologists and geophysicists perform seismic surveys to map and interpret sedimentary facies and other geologic features for applications including identification of potential petroleum reservoirs. Seismic surveys are conducted by using a controlled seismic source (for example, a seismic vibrator or dynamite) to create seismic waves. The seismic source is typically located at ground surface. Seismic body waves travel into the ground, are reflected by subsurface formations, and return to the surface where they recorded by sensors called geophones. Seismic surface waves travel along the ground surface and diminish as they get further from the surface. Seismic surface waves travel more slowly than seismic body waves. The geologists and geophysicists analyze the time it takes for the seismic body waves to reflect off subsurface formations and return to the surface to map sedimentary facies and other geologic features. Similarly, analysis of the time it takes seismic surface waves to travel from source to sensor can provide information about near surface features. This analysis can also incorporate data from sources, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

The technology relates to methods and systems for determining the thickness of a reservoir sediment (glacial) channels by training machine learning models with labeled seismic data. Specifically, a set of attributes from seismic data is selected that is predictive of channel thickness between the base and top of the channel. The channel thickness generally cannot be determined directly from seismic data because of the variation in depth of the base location in the channel. In addition, channels differ in thickness between each other. The base location is below seismic resolution in many cases. The attributes identified in the seismic data are measurable in the seismic data and predictive of channel thickness.

The data processing system and processes described herein enable one or more of the following advantages. A conventional approach for predicting channels thickness is to pick a surface at a channel top using seismic data, but to pick a base of channel based on geological estimates. This approach has a high margin of error because the base of the channel varies from one location to another. A velocity model that is created from velocity well logs is used to convert seismic from time to depth. The top channel surface is then subtracted from the base channel surface to get the thickness.

The data processing system described herein overcomes these technical problems by using a specific set of seismic attributes for both determining the top of the glacial channel and the bottom of the glacial channel. The data processing system is configured to determine the complex depositional and diagenetic history of reservoir intervals in which the rock typing varies from shale, silt and variable sizes of sand grains sizes and sorting. The data processing system is configured to enable exploration and development in proglacial Ordovician channels by estimating the pre-drill thickness of the channel. A control system uses the results to control drilling depths and locations in the subsurface. The predicted thickness is accurate to within 16%.

The data processing system solves technical problems that have an operational impact related to reservoir modeling and resources estimation. First, the data processing system reduces an uncertainty in estimating thickness of the channel. The channel is the main reservoir of areas with glacial channels. The data processing system and control system control the drilling process to avoid drilling extra footage below the channel, saving rig time and costs. The data processing system and control system enable a decision for drilling the well in a particular glacial channel. Second, the data processing system enables faster interpretation of the channel base. Third, data processing system lowers a risk of generating a non-unique interpretation of the seismic data such that the glacial thickness cannot be determined. The data processing system trains the machine learning model on a limited set of predefined geological models. The use of a specific set of training data decreases the impact of the non-unique interpretation of the seismic data which will yield more accurate estimation of the channel thickness and consequently better estimation of hydrocarbons in-place in the reservoir. Embodiments of these systems and methods can include one or more of the following features.

In a general aspect, a process for drilling a hydrocarbon well in a subterranean formation based on channel thicknesses include the following. The process includes receiving seismic data for the subterranean formation. The process includes extracting values for seismic attributes from the seismic data. The process includes executing a machine learning model trained using synthetic seismic attribute values that are associated with true values of channel thicknesses for synthetic channels. The machine learning model receives the extracted values for the seismic attributes as input values. The process includes generating, based on the executing, at least one predicted value of a channel thickness for a channel in the subterranean formation. The process includes generating, based on the at least one predicted value of the channel thickness for the channel, a map of the subterranean formation including the channel.

In some implementations, the process includes controlling a depth of a drilling process in the channel based on the at least one predicted value of the channel thickness.

In some implementations, the process includes generating the synthetic seismic attribute values by performing operations including generating a geological framework for a three-dimensional (3D) geological model; generating channel models for the synthetic channels within the geological framework; determine P-wave velocities, S-wave velocities, and density functions for the geological model;

performing a convolution of the S-wave velocities, the P-wave velocities, and the density functions into time domain from depth domain; generating, based on the convolution, an isotropic synthetic seismic volume; and extracting, from the isotropic synthetic seismic volume, synthetic seismic attribute values.
In some implementations, a seismic reflector for the seismic data comprises a layer of the subterranean formation that is below a base of the channel.

In some implementations, the seismic attributes are selected from a group comprising: an average envelope value; a frequency filter; an average magnitude; a sum of negative amplitudes; a maximum amplitude; a general spectral decomposition; a time at minimum amplitude; an iso-frequency component at 5 Hz; a time at maximum amplitude; a general spectral decomposition at 10 Hz; a local flatness; and a channel differentiation attribute.

In some implementations, the machine learning model comprises an extra trees regression model configured to generate at least 100 trees with different initialization points and select an optimal initialization point from the different initialization points.

In some implementations, the process includes validating the least one predicted value of the channel thickness in the subterranean formation by comparing the at least one predicted value of the channel thickness to a measured channel thickness of the channel.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of a seismic survey being performed to map subterranean features such as facies and faults.

FIG. 2 illustrates a three-dimensional cube representing a subterranean formation.

FIG. 3 illustrates a stratigraphic trace within the three-dimensional cube of FIG. 2.

FIG. 4 shows an example process for determining thickness of glacial channels from seismic surveys.

FIG. 5 shows an example process for determining thickness of glacial channels from seismic surveys.

FIG. 6 shows an example visualization of a three-dimensional model framework.

FIG. 7 shows an example visualization of a channel model of the geological model.

FIG. 8 shows an example process for determining thickness of glacial channels from seismic surveys.

FIG. 9 shows an example process for generation of a synthetic seismic volume.

FIG. 10 shows an example process for determining thickness of glacial channels from seismic surveys.

FIG. 11 shows an example process for applying machine learning models to data of the synthetic seismic volume.

FIG. 12 shows an example of selection of surfaces within the synthetic seismic volume for use in attribute generation that is performed for training the machine learning model of FIG. 11.

FIG. 13 shows an example of generated values for channel thickness prediction based on execution of the machine learning model of FIG. 11.

FIG. 14 is a graph showing precisions for example predictions output by the machine learning model.

FIG. 15 shows an example process for determining thickness of glacial channels from seismic surveys.

FIG. 16 illustrates a workflow for example hydrocarbon production operations.

FIG. 17 is a diagram of an example computing system.

### DETAILED DESCRIPTION

This specification describes a data processing system and control system configured to determine thicknesses of glacial channels from seismic surveys. The control system can be configured to control drilling of wells in a geological region based on the determined thicknesses of the glacial channels in the geological region.

A seismic reflector below the base channel is suitable for determining channel thickness. This is because channel thickness differs from location to another in the same channel. The thickness is different between different channels. The base of the channel is not a flat surface and cannot be picked as a normal surface, and there is a lot of uncertainty in picking it. Based on drilled channels wells data, a seismic reflector is chosen that is entirely beneath the base of the channel to ensure that whole channels are captured. Once the whole channel from top to bottom is captured, a machine learning model determines the thickness between the channel top and base.

A challenge in predicting channels thickness results from a high uncertainty in picking a base of the channel. The channel base is not clear from seismic data because it typically is below seismic resolution and because the base depth varies from one location to another. Because the base channel is not a flat surface, conventional approaches use manual picking from exhaustive surveys.

The data processing system is configured to predict the thickness of a glacial channel using a trained machine learning model. The machine learning model uses well data as input data and outputs a prediction of the thicknesses of glacial channels for generation of a map of the region with the glacial channels indicated in the region.

The data processing system trains the machine learning engine in a supervised process. The data processing system trains the machine learning model with inputs including seismic attributes from a synthetic seismic volume generated from a geological model that mimics wells data. The data processing system then applies the trained models using, as input data, seismic attributes from real seismic data to predict channels thickness for channels at or near the wells.

The machine learning model can include the following. The machine learning model can include a regression model to predict channels thickness. The attributes for training the model were selected as a subset from a larger set of attributes, as described herein. For generating the synthetic seismic data, the data processing system generates a three-dimensional model that models wells in terms of P-wave velocity, S-wave velocity, and density values. The well models are labeled as input data for training the machine learning model.

The data processing system can generate a visualization of the glacial channels within a region. The data processing system can compare predicted thicknesses of glacial channels to actual glacial thicknesses in a particular region to validate the machine learning model. For example, to validate the predictions of the machine learning model, measured channels are mapped to real seismic data in a two-dimensional (2D) view.

The data processing system described herein determines a thickness of glacial channels in a subsurface. The data processing system can control, based on the thickness, a drilling system to drill to a specific depth that is not below the bottom of the channel.

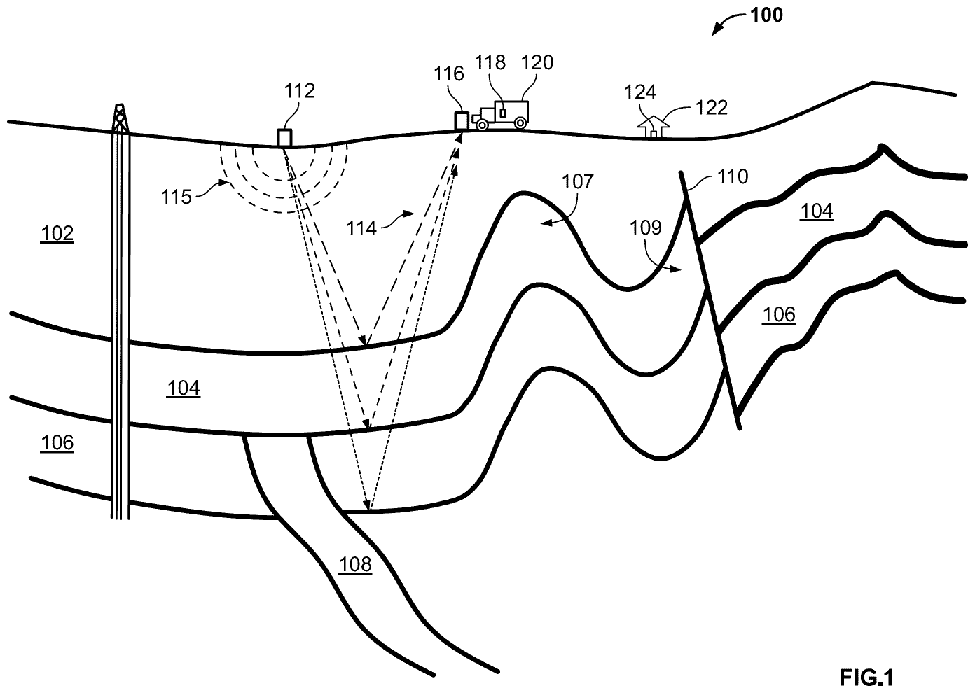

FIG. 1 is a schematic view of a seismic survey being performed to map subterranean features such as facies and faults in a subterranean formation 100 under a marine feature (such as under the sea or ocean). The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source (or sources) 112 are typically a line or an array of sources 112. The generated seismic waves include seismic body waves 114 that travel into the ground and seismic surface waves 115 travel along the ground surface and diminish as they get further from the marine surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer systems 124 may be displayed for user viewing using local or remote monitors or other display units. One approach to analyzing seismic data is to associate the data with portions of a seismic cube representing the subterranean formation 100. The seismic cube can also display results of the analysis of the seismic data associated with the seismic survey.

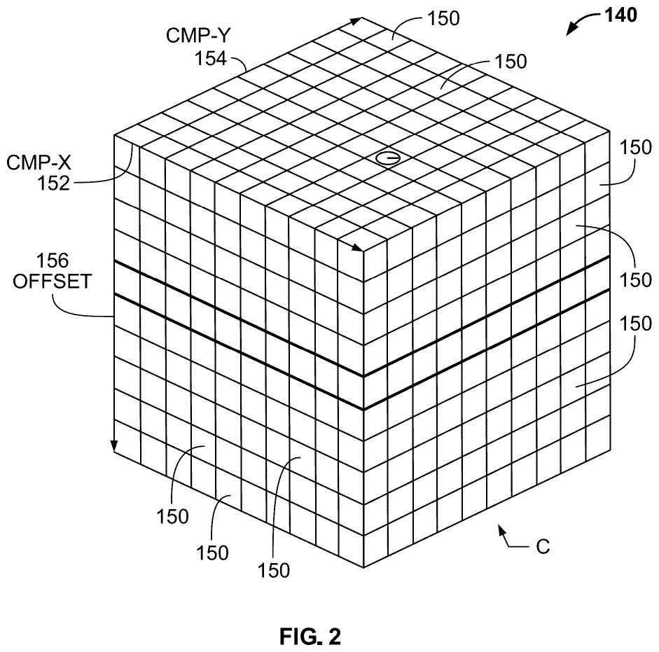

FIG. 2 illustrates seismic trace sorting into CMP-offset bins 150. The multi-dimensional attribute cubes or bins are used for quality control since these cubes or bins 150 enable a visualization of the spatial trends of the travel time (mean values) and the noisy areas (standard deviation). When performing the 3D CMP-offset binning (that is, XYO binning in the directions of CMP-X 152, CMP-Y 154, and offset 156), the bin sizes in the CMP-X 152 and CMP-Y 154 directions can be kept greater, such that enough CMPs are placed in a bin 150 to provide functionally applicable statistics. The XYO binning illustrated in FIG. 2 is different from sorting in a common offset domain as the latter collects data sharing a common offset but pertaining to different CMPs. The existing CMP sorting (time-offset) that is applied for reflected waves is less useful for refracted waves as it would display events with variable velocities over the offset axis. The XYO binning method is therefore an effective representation of both CMP and offset domains where common properties at a CMP position can be assessed.

In some implementations, as shown in FIG. 2, the XYO space 140 is divided into XYO cubes or bins 150 of a particular size. For example, each bin 150 can have a size of 100 meters (m) in the CMP-X direction, 100 m in the CMP-Y direction, and 50 m in the offset direction. For each trace (or first break pick), the offset (the distance between the source and the receiver) and the CMP (the middle point position between the source and the receiver) are determined, and the trace is sorted into a particular bin based on the offset and the CMP. Each XYO bin 150 includes a collection of traces sharing a common (or similar) midpoint position and a common (or similar) offset. The collection of traces in an XYO bin is sometimes referred to as an XYO gather.

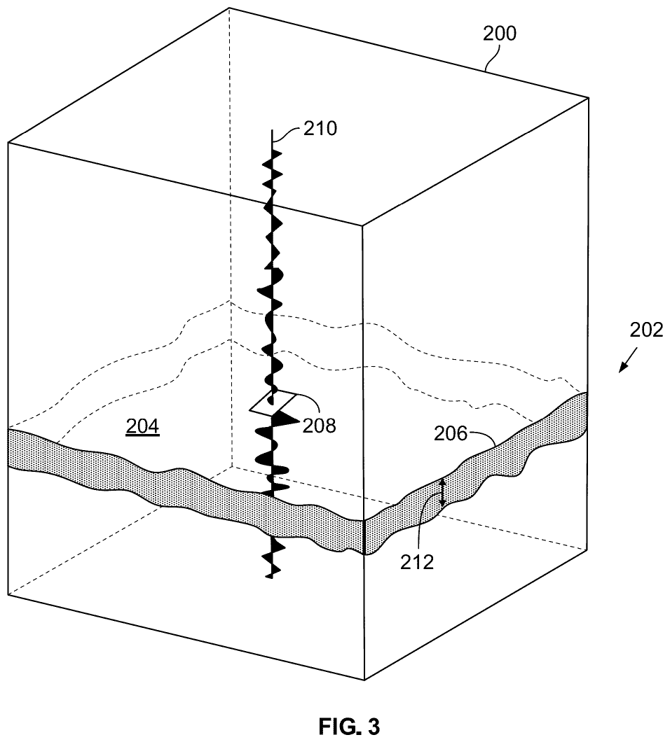

FIG. 3 illustrates a seismic cube 200 representing a formation. The seismic cube has a stratum 202 based on a surface (for example, an amplitude surface 204) and a stratigraphic horizon 206. The amplitude surface 204 and the stratigraphic horizon 206 are grids that include many cells such as exemplary cell 208. Each cell is a sample of a seismic trace representing an acoustic wave. Each seismic trace has an x-coordinate and a y-coordinate, and each data point of the trace corresponds to a certain seismic travel time or depth (t or z). For the stratigraphic horizon 206, a time value is determined and then assigned to the cells from the stratum 202. For the amplitude surface 204, the amplitude value of the seismic trace at the time of the corresponding horizon is assigned to the cell. This assignment process is repeated for all the cells on this horizon to generate the amplitude surface 204 for the stratum 202. In some instances, the amplitude values of the seismic trace 210 within window 212 by horizon 206 are combined to generate a compound amplitude value for stratum 202. In these instances, the compound amplitude value can be the arithmetic mean of the positive amplitudes within the duration of the window, multiplied by the number of seismic samples in the window.

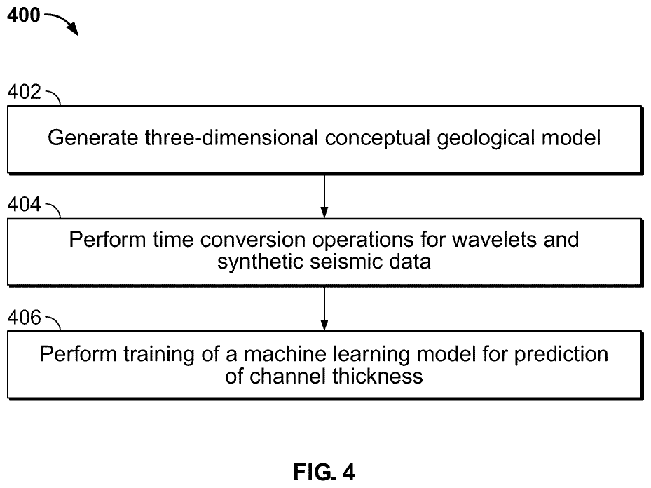

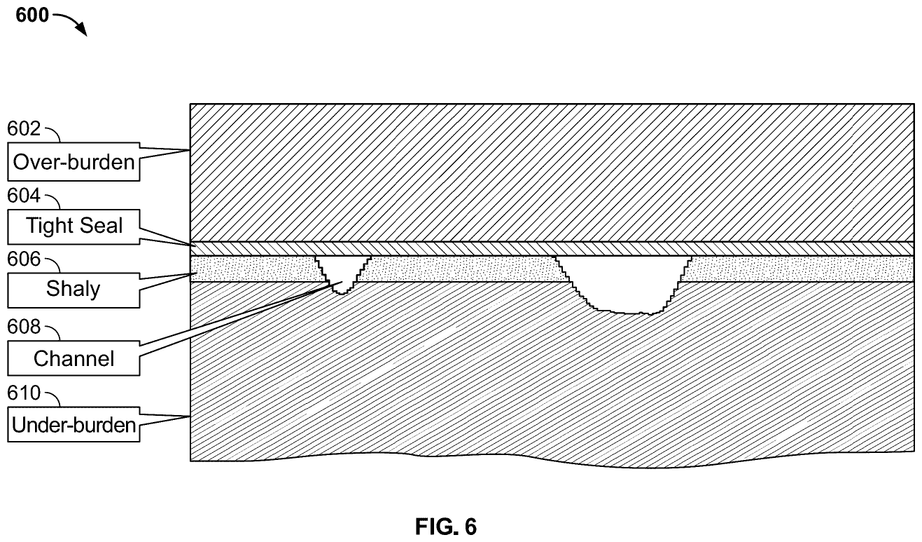

FIG. 4 shows an example process 400 for determining thickness of glacial channels from seismic surveys. The process 400 includes generating (402) a three-dimensional (3D) conceptual geological model. The data processing system builds the model as a layer-cake box. An example of this model 600 is shown in FIG. 6. In some implementations, the framework horizons are over-burden 602 of 500-foot (ft) thickness, channels formation 608 with varying thickness, shaly formation 606 outside the channel of 100 ft thickness, and under-burden 610 with varying thickness+/−500 ft. The channel formation 608 possesses two layers: a layer cake tight-seal 604 of around 50 ft thickness of eustasy depositional environment, and the proglacial channels. The channel is known to have variable thickness by observation of well data, seismic data, and outcrop data. These values mimic the reality in geological settings based on the available seismic data resolution and available well data captured from drilled wells.

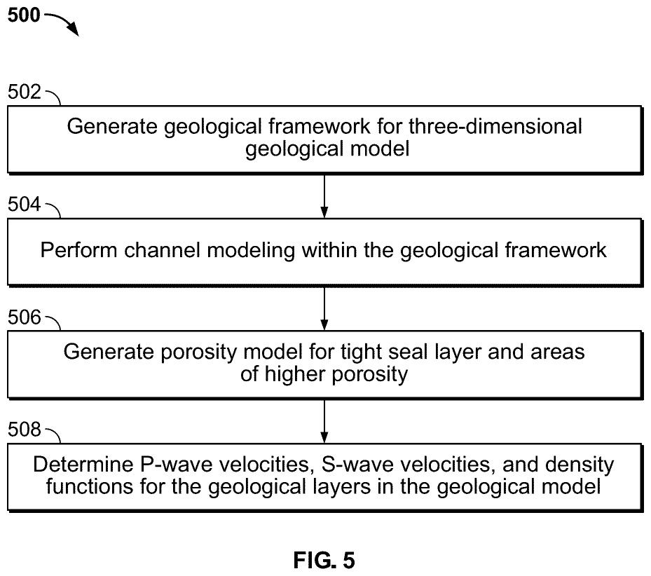

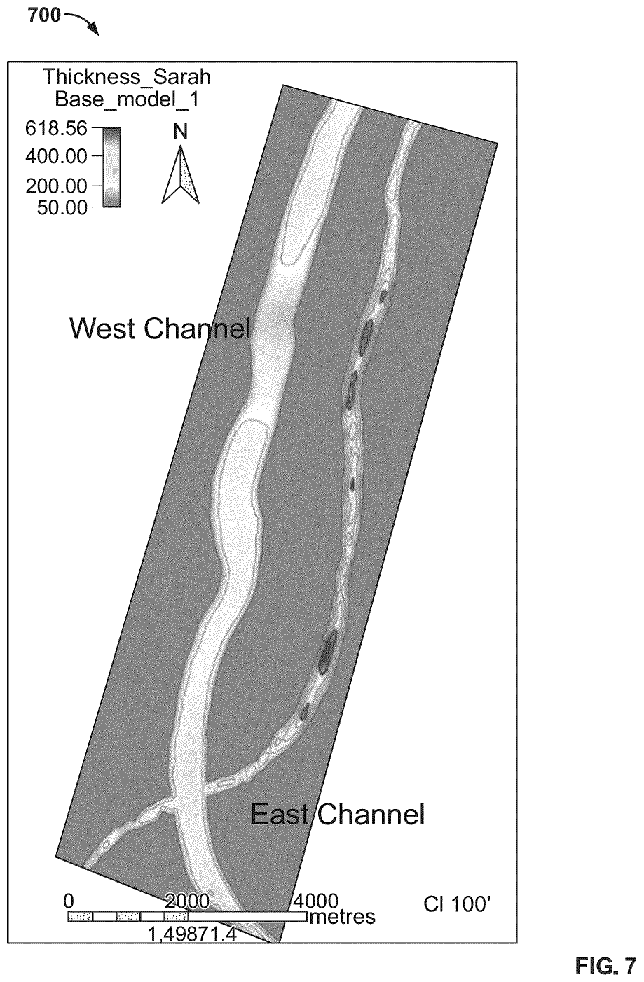

The data processing system performs generation of the 3D conceptual model as shown, for example, in FIG. 5. The data processing system is configured to generate (502) a geological framework for three-dimensional geological model. The data processing system performs (504) channel modeling within the geological framework. As shown in FIG. 7, a model 700 includes two proglacial channels (“east channel” and “west channel”) with a variation in thickness. The two channels are modeled using Ordovician database channel width data and are based on well penetrations and analog data from the region. The data processing system uses these data to define the thicknesses of the channels for the synthetic data. The Ordovician dataset mimics actual channels in each area for a particular machine learning model training process to provide a maximum accuracy in predicting channels thicknesses for regions with glacial channels. However, other datasets can be used for this purpose to train machine learning models for other regions with glacial channels.

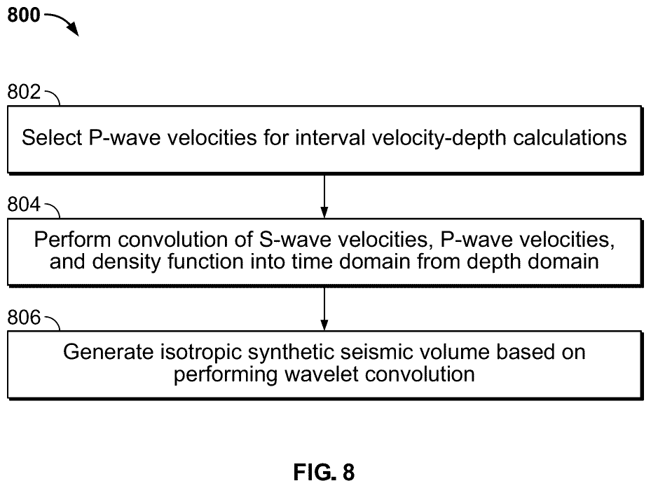

The process 500 includes generating (504), by the data processing system, a porosity model for tight seal layer and areas of higher porosity. The process 500 includes determining (506), by the data processing system, p-wave velocities, s-wave velocities, and density functions for the geological layers in the geological model. The velocities and density functions are inputs for the process described in relation to FIG. 8.

Returning to FIG. 4, the process 400 includes performing (404) time conversion operations for wavelets and synthetic seismic data. For example, density, P-wave velocity, and S-wave velocity are converted from depth to time. The data processing system performs depth to time conversion to convolve the density model, P-wave velocity model, and S-wave velocity model with a multi-well deterministic wavelet that is extracted from the wells within the seismic block including the channels. A synthetic volume is then generated out of the convolution process, as subsequently described. This process descried further in relation to FIG. 8.

FIG. 8 shows an example process 800 for determining thickness of glacial channels from seismic surveys. The data processing system is configured to select (802) p-wave velocities for interval velocity-depth calculations. The data processing system performs (804) conversion of S-wave velocities, P-wave velocities, and a density function into the time domain from the depth domain. The data processing system generates (806) an isotropic synthetic seismic volume based on performing a wavelet convolution. The P-wave velocity, S-wave velocity, and density values are used from sonic and density wireline logs acquired actual drilled wells. These values are used to construct the synthetic geological model that is used for training the machine learning models. These three geological volumes are convolved with a multi-well deterministic wavelet that is extracted from the wells within the seismic block in which there are channel thicknesses for predicting. The data processing system thus generates a synthetic volume out of the convolution process.

Three wells penetration are used as type wells for the three main categories in the model. P-wave velocity, S-wave velocity, and density values were used from the sonic and density wireline logs acquired post drilling the section. The western channel of model 700 is a tight channel and a drilled tight well log values were used to populate Vₚ, Vₛ and density volumes. The eastern channel is heterogeneous channel that possesses multiple porosity areas within the tight background. A combination of different drilled porous wells can be used. Outside the channel system, a non-channel drilled well is used to populate that area of the model 700 with velocities and density data. The eastern channel modeling is more complex because it includes modeling four porous polygons within the tight channel.

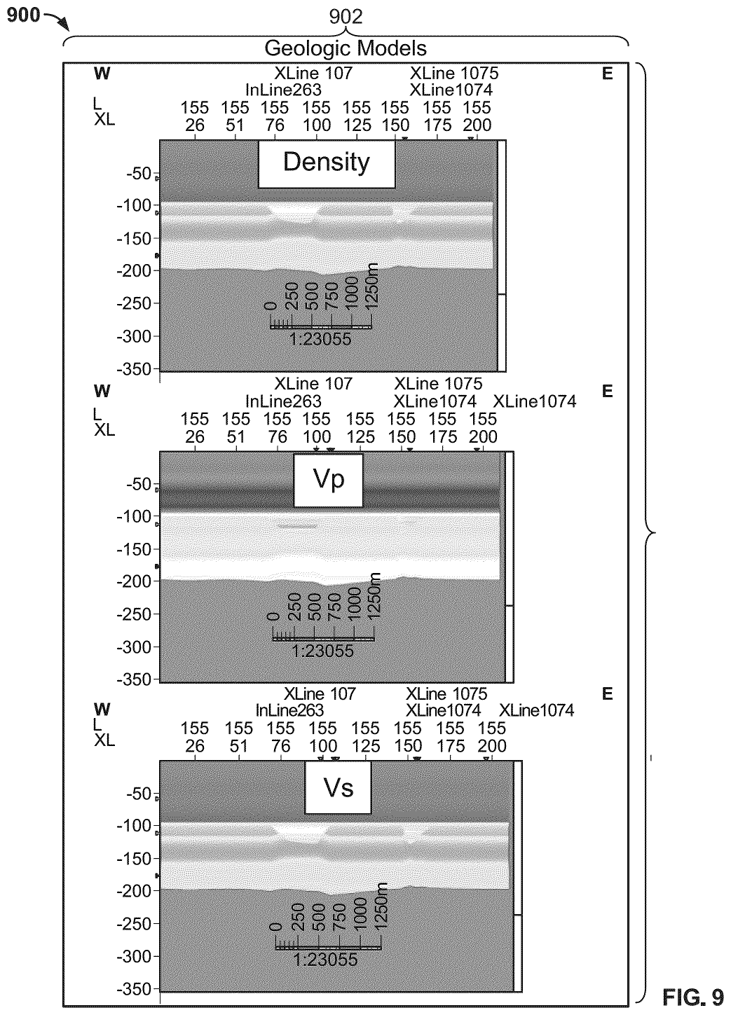

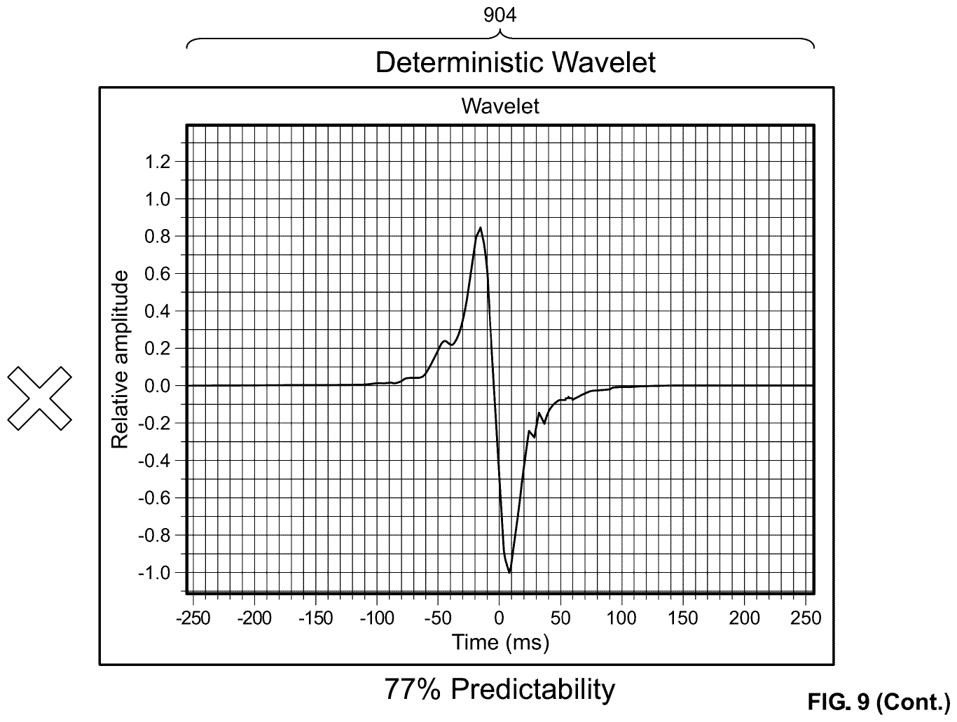

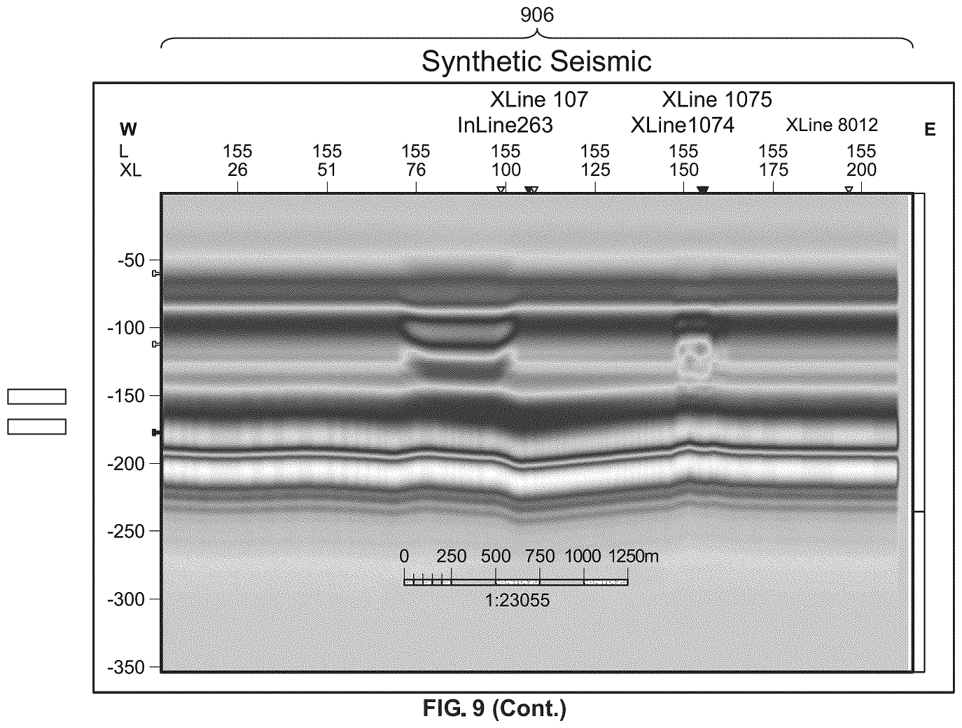

FIG. 9 shows an example process 900 for generation of a synthetic seismic volume. The geological models 902 include density, P-wave velocity, and S-wave velocity, as previously described. These models are convolved with a deterministic wavelet 904, as previously described, to transform the data into the time domain from the depth domain. The process 900 generates synthetic seismic data 906 as an output.

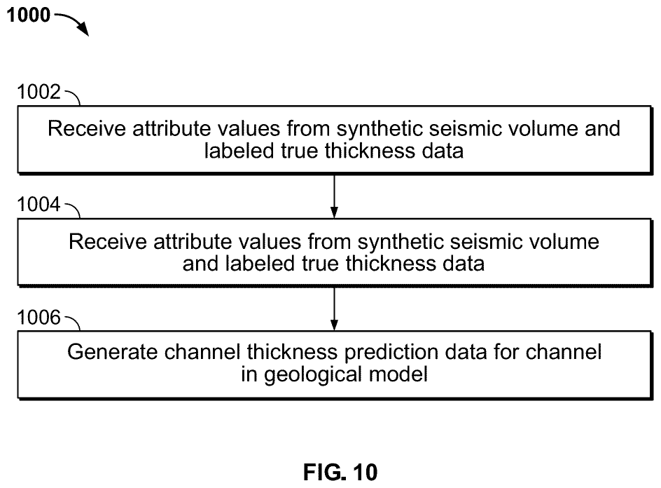

Returning to FIG. 4, the data process system is configured to perform (406) training of the machine learning model for prediction of channel thickness. This process is shown in more detail in FIG. 10.

FIG. 10 shows an example process 1000 for determining thickness of glacial channels from seismic surveys. The process 1000 includes receiving (1002) attribute values from synthetic seismic volume and labeled true thickness data. The process 1000 includes receiving (1004) attribute values from synthetic seismic volume and labeled true thickness data. The process 1000 includes generating (1006) channel thickness prediction data for channels in geological model.

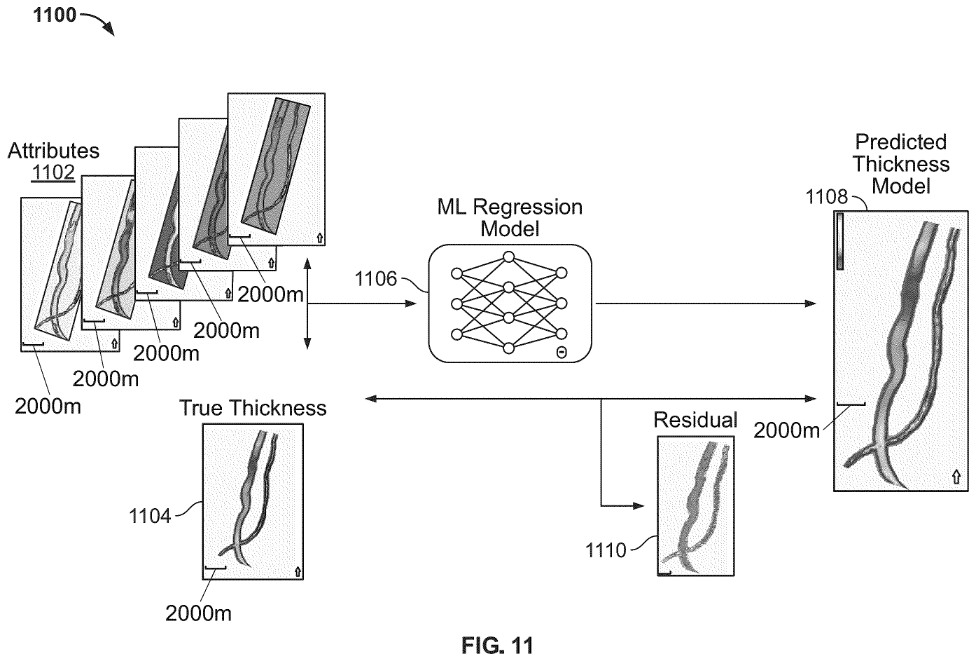

FIG. 11 shows an example process 1100 for applying machine learning models to data of the synthetic seismic volume. Attributes data 1102 from the field near the channels are input into a machine learning model 1106. The machine learning model 1106 is trained using true thickness data 1104 from a training data source (e.g., field data from another region), as well as attribute data from the training data source corresponding to regions with known thickness. As previously discussed, the true thicknesses “label” the attributes data obtained from transforming the wireline logs into synthetic seismic data.

The machine learning regression model to predict channels thickness utilizes supervised data training on seismic attributes from the synthetic seismic volume generated earlier from the geological models. The training model is iterated until the residual between the model true thickness and predicted thickness at minimum. The data processing system applies trained machine learning model on seismic attributes from real seismic data to predict channels thickness.

Examples of seismic attributes are now provided. Each attribute has a value corresponding to a location in the seismic volume (on an XY coordinate plane in the seismic volume). The data processing system derives the attributes from seismic amplitudes. The data processing system normalizes attribute and scales the attribute values to form the training data for training the machine learning model to predict channels thickness. A specific attribute value does not directly correlate to the output of the predicted channels thickness. Rather, the values of the attributes together at locations within the seismic volume contribute to prediction of the channel thickness.

From a set of 40 available attributes, twelve are selected. The twelve selected attributes provide the most accurate predictions of the channel thicknesses when used in the machine learning model. Specifically, all 40 attributes were initially analyzed reduced to twelve based on their contribution to the training model. The selection of attributes was done using permutation importance. Permutation importance is a model that decreases the regression training model prediction accuracy when each single attribute is removed. While there is no specific threshold for contribution, a noticeable difference resulted between the contribution of the 12th attribute and the rest of 40 attributes that were removed. After the 12th attribute, the contribution of the remaining 28 attributes had a very similar contribution and it was flat.

Examples of the twelve attributes for training the machine learning model, based on their contribution to the training model include the following. The attributes include: an average envelope value; a frequency filter; an average magnitude; a sum of negative amplitudes; a maximum amplitude; a general spectral decomposition (e.g., at 30 Hertz (Hz)); a time at minimum amplitude; an iso-frequency component (e.g., at 5 Hz); a time at maximum amplitude; a general spectral decomposition (e.g., at 10 Hz); a local flatness; and a channel differentiation attribute. The data processing system generates the channel differentiation attribute by mapping all the channels in the block. The data processing system then generates a surface assigns a constant value of one to the areas inside the channels and a value of zero to the areas outside the channels. The data processing system trains the machine learning model using the attributes extracted from the synthetic seismic volume.

The machine learning model can include an extra trees regression model. The extra trees regression model includes a supervised machine learning model that uses decision trees to regress the data using true or false answers. The extra trees regression model generates many decision trees with a dataset for each tree with unique samples. The model the optimal decision tree structure model that fits the data. In an example, the data processing system generates an extra trees regression model that generates 100 trees with different initialization points. The model then chooses an optimal initialization point. Each tree is split into a minimum of 4 samples using a maximum of 6 features of each sample. These parameters are selected because they provide the most accurate results upon running different models.

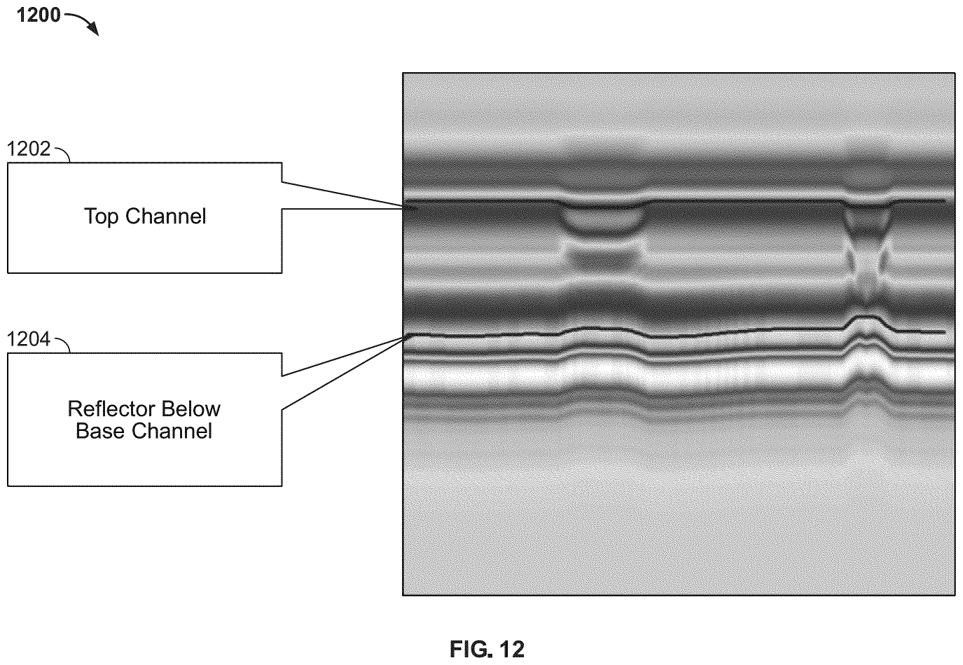

FIG. 12 shows an example of selection of surfaces within the synthetic seismic volume for use in attribute generation that is performed for training the machine learning model of FIG. 11. Training results are then applied on the real seismic data 1200 on the same twelve attributes that are extracted using the same method as the synthetic seismic earlier which is between the tops of the channels 1202 and a reflector 1204 that is below all the channel bottoms. The data processing system picks the top of the channel based on seismic data. Because the data processing system cannot pick the base of channel cannot based on seismic data, as the depth of the bottom of the channel varies from one location to another and is below seismic resolution, the data processing system selects a seismic reflector that is below all the channels.

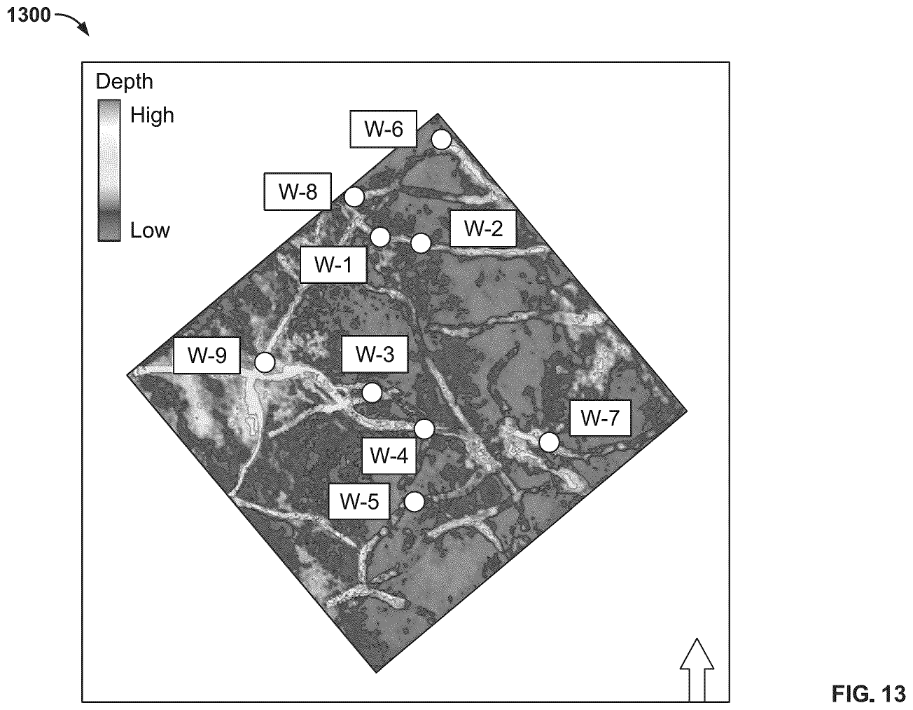

FIG. 13 shows an example of generated values for channel thickness prediction based on execution of the machine learning model of FIG. 11. Channel thickness prediction results are 84% accurate compared to the channels thickness encountered in the nine drilled wells in the area, shown in visualization 1300. Nine wells (W1-W9 are shown as providing the basis of wireline and/or seismic data. The predictions of channel depths are shown as a gradient.

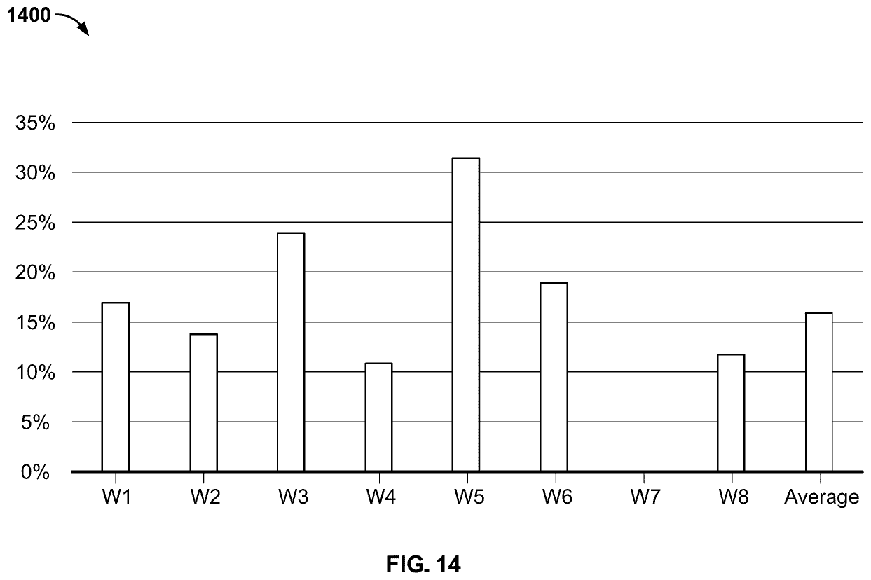

FIG. 14 is a graph 1400 showing precisions for example predictions output by the machine learning model. This graph 1400 displays the error percentage for predicted channels thickness against true channels thickness at the drilled wells' locations. Average error percentage is 16%.

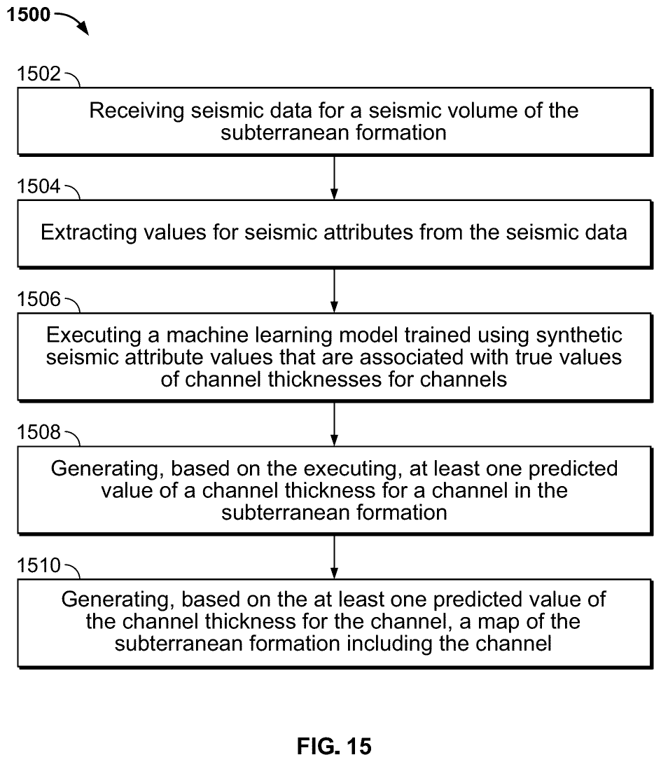

FIG. 15 shows an example process 1500 for determining thickness of glacial channels from seismic surveys. The process includes receiving (1502) seismic data for a seismic volume of the subterranean formation. The process includes extracting (1504) values for seismic attributes from the seismic data. The process includes executing (1506) a machine learning model trained using synthetic seismic attribute values that are associated with true values of channel thicknesses for channels. The machine learning model receives the extracted values for the seismic attributes as input values. The process 1500 includes generating (1508), based on the executing, at least one predicted value of a channel thickness for a channel in the subterranean formation. The process 1500 includes generating (1510), based on the at least one predicted value of the channel thickness for the channel, a map of the subterranean formation including the channel.

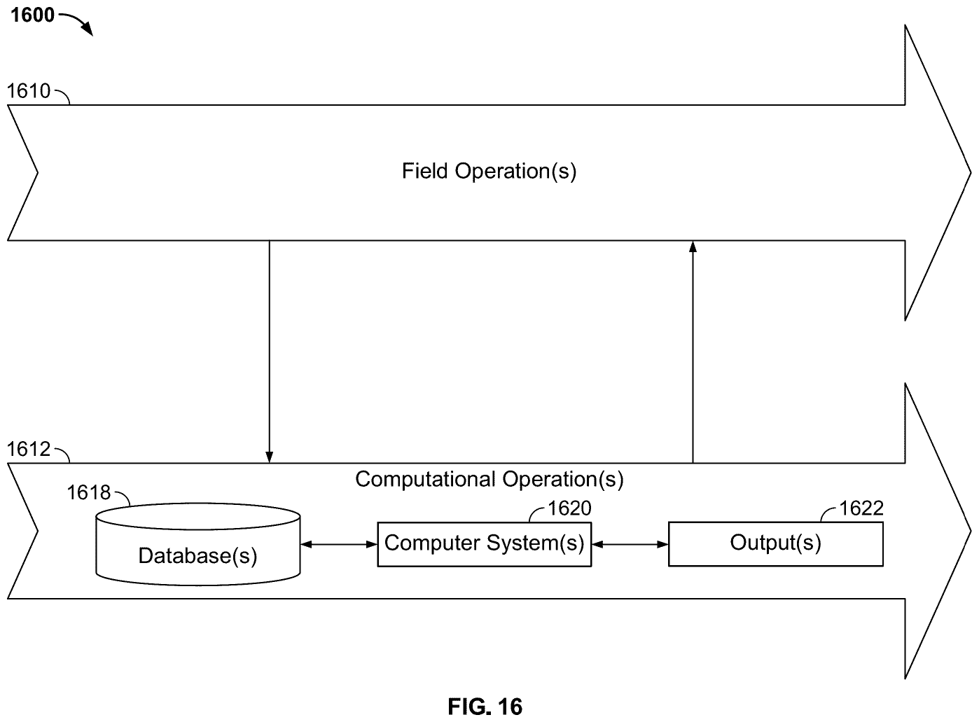

FIG. 16 illustrates hydrocarbon production operations 1600 that include both one or more field operations 1610 and one or more computational operations 1612, which exchange information and control exploration to produce hydrocarbons. In some implementations, outputs of techniques of the present disclosure (e.g., the method 300) can be performed before, during, or in combination with the hydrocarbon production operations 1600, specifically, for example, either as field operations 1610 or computational operations 1612, or both. For example, the method 300 collects data during field operations, processes the data in computational operations, and can determine locations to perform additional field operations.

Examples of field operations 1610 include forming/drilling a wellbore, hydraulic fracturing, producing through the wellbore, injecting fluids (such as water) through the wellbore, to name a few. In some implementations, methods of the present disclosure can trigger or control the field operations 1610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1610 and responsively triggering the field operations 1610 including, for example, generating plans and signals that provide feedback to and control physical components of the field operations 1610. Alternatively, or in addition, the field operations 1610 can trigger the methods of the present disclosure. For example, implementing physical components (including, for example, hardware, such as sensors) deployed in the field operations 1610 can generate plans and signals that can be provided as input or feedback (or both) to the methods of the present disclosure.

Examples of computational operations 1612 include one or more computer systems 1620 that include one or more processors and computer-readable media (e.g., non-transitory computer-readable media) operatively coupled to the one or more processors to execute computer operations to perform the methods of the present disclosure. The computational operations 1612 can be implemented using one or more databases 1618, which store data received from the field operations 1610 and/or generated internally within the computational operations 1612 (e.g., by implementing the methods of the present disclosure) or both. For example, the one or more computer systems 1620 process inputs from the field operations 1610 to assess conditions in the physical world, the outputs of which are stored in the databases 1618. For example, seismic sensors of the field operations 1610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1612 where they are stored in the databases 1618 and analyzed by the one or more computer systems 1620.

In some implementations, one or more outputs 1622 generated by the one or more computer systems 1620 can be provided as feedback/input to the field operations 1610 (either as direct input or stored in the databases 1618). The field operations 1610 can use the feedback/input to control physical components used to perform the field operations 1610 in the real world.

For example, the computational operations 1612 can process the seismic data to generate three-dimensional (3D) maps of the subsurface formation. The computational operations 1612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1612 to process new information about the formation and control the drilling to adjust to the observed conditions in real-time.

The one or more computer systems 1620 can update the 3D maps of the subsurface formation as information from one exploration well is received and the computational operations 1612 can adjust the location of the next exploration well based on the updated 3D maps. Similarly, the data received from production operations can be used by the computational operations 1612 to control components of the production operations. For example, production well and pipeline data can be analyzed to predict slugging in pipelines leading to a refinery and the computational operations 1612 can control machine operated valves upstream of the refinery to reduce the likelihood of plant disruptions that run the risk of taking the plant offline.

In some implementations of the computational operations 1612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

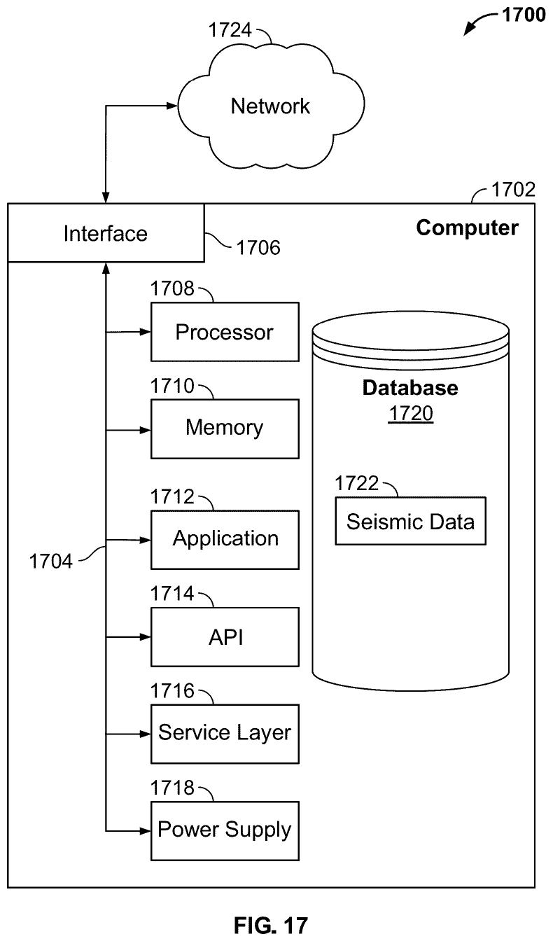

FIG. 17 is a block diagram of an example computer system 1700 used to provide computational functionalities associated with described algorithms, methods, functions, processes, flows, and procedures described in the present disclosure, according to some implementations of the present disclosure. The illustrated computer 1702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1702 can include input devices such as keypads, keyboards, and touch screens that can accept user information. Also, the computer 1702 can include output devices that can convey information associated with the operation of the computer 1702. The information can include digital data, visual data, audio information, or a combination of information. The information can be presented in a graphical user interface (UI) (or GUI).

The computer 1702 can serve in a role as a client, a network component, a server, a database, a persistency, or components of a computer system for performing the subject matter described in the present disclosure. The illustrated computer 1702 is communicably coupled with a network 1724. In some implementations, one or more components of the computer 1702 can be configured to operate within different environments, including cloud-computing-based environments, local environments, global environments, and combinations of environments.

At a high level, the computer 1702 is an electronic computing device operable to receive, transmit, process, store, and manage data and information associated with the described subject matter. According to some implementations, the computer 1702 can also include, or be communicably coupled with, an application server, an email server, a web server, a caching server, a streaming data server, or a combination of servers.

The computer 1702 can receive requests over network 1724 from a client application (for example, executing on another computer 1702). The computer 1702 can respond to the received requests by processing the received requests using software applications. Requests can also be sent to the computer 1702 from internal users (for example, from a command console), external (or third) parties, automated applications, entities, individuals, systems, and computers.

Each of the components of the computer 1702 can communicate using a system bus 1704. In some implementations, any or all of the components of the computer 1702, including hardware or software components, can interface with each other or the interface 1706 (or a combination of both), over the system bus 1704. Interfaces can use an application programming interface (API) 1714, a service layer 1716, or a combination of the API 1714 and service layer 1716. The API 1714 can include specifications for routines, data structures, and object classes. The API 1714 can be either computer-language independent or dependent. The API 1714 can refer to a complete interface, a single function, or a set of APIs.

The service layer 1716 can provide software services to the computer 1702 and other components (whether illustrated or not) that are communicably coupled to the computer 1702. The functionality of the computer 1702 can be accessible for all service consumers using this service layer. Software services, such as those provided by the service layer 1716, can provide reusable, defined functionalities through a defined interface. For example, the interface can be software written in JAVA, C++, or a language providing data in extensible markup language (XML) format. While illustrated as an integrated component of the computer 1702, in alternative implementations, the API 1714 or the service layer 1716 can be stand-alone components in relation to other components of the computer 1702 and other components communicably coupled to the computer 1702. Moreover, any or all parts of the API 1714 or the service layer 1716 can be implemented as child or sub-modules of another software module, enterprise application, or hardware module without departing from the scope of the present disclosure.

The computer 1702 includes an interface 1706. Although illustrated as a single interface 1706 in FIG. 17, two or more interfaces 1706 can be used according to implementations of the computer 1702 and the described functionality. The interface 1706 can be used by the computer 1702 for communicating with other systems that are connected to the network 1724 (whether illustrated or not) in a distributed environment. Generally, the interface 1706 can include, or be implemented using, logic encoded in software or hardware (or a combination of software and hardware) operable to communicate with the network 1724. More specifically, the interface 1706 can include software supporting one or more communication protocols associated with communications. As such, the network 1724 or the interface's hardware can be operable to communicate physical signals within and outside of the illustrated computer 1702.

The computer 1702 includes a processor 1708. Although illustrated as a single processor 1708 in FIG. 17, two or more processors 1708 can be used according to implementations of the computer 1702 and the described functionality. Generally, the processor 1708 can execute instructions and can manipulate data to perform the operations of the computer 1702, including operations using algorithms, methods, functions, processes, flows, and procedures as described in the present disclosure.

The computer 1702 also includes a database 1720 that can hold data for the computer 1702 and other components connected to the network 1724 (whether illustrated or not). For example, database 1720 can be an in-memory, conventional, or a database storing data consistent with the present disclosure. In some implementations, database 1720 can be a combination of two or more different database types (for example, hybrid in-memory and conventional databases) according to implementations of the computer 1702 and the described functionality. Although illustrated as a single database 1720 in FIG. 17, two or more databases (of the same, different, or combination of types) can be used according to implementations of the computer 1702 and the described functionality. While database 1720 is illustrated as an internal component of the computer 1702, in alternative implementations, database 1720 can be external to the computer 1702.

The computer 1702 also includes a memory 1710 that can hold data for the computer 1702 or a combination of components connected to the network 1724 (whether illustrated or not). Memory 1710 can store any data consistent with the present disclosure. In some implementations, memory 1710 can be a combination of two or more different types of memory (for example, a combination of semiconductor and magnetic storage) according to implementations of the computer 1702 and the described functionality. Although illustrated as a single memory 1710 in FIG. 17, two or more memories 1710 (of the same, different, or combination of types) can be used according to implementations of the computer 1702 and the described functionality. While memory 1710 is illustrated as an internal component of the computer 1702, in alternative implementations, memory 1710 can be external to the computer 1702.

The application 1718 can be an algorithmic software engine providing functionality according to implementations of the computer 1702 and the described functionality. For example, application 1718 can serve as one or more components, modules, or applications. Further, although illustrated as a single application 1718, the application 1718 can be implemented as multiple applications 1718 on the computer 1702. In addition, although illustrated as internal to the computer 1702, in alternative implementations, the application 1718 can be external to the computer 1702.

The computer 1702 can also include a power supply 1718. The power supply 1718 can include a rechargeable or non-rechargeable battery that can be configured to be either user- or non-user-replaceable. In some implementations, the power supply 1718 can include power-conversion and management circuits, including recharging, standby, and power management functionalities. In some implementations, the power-supply 1718 can include a power plug to allow the computer 1702 to be plugged into a wall socket or a power source to, for example, power the computer 1702 or recharge a rechargeable battery.

There can be any number of computers 1702 associated with, or external to, a computer system containing computer 1702, with each computer 1702 communicating over network 1724. Further, the terms “client,” “user,” and other appropriate terminology can be used interchangeably, as appropriate, without departing from the scope of the present disclosure. Moreover, the present disclosure contemplates that many users can use one computer 1702 and one user can use multiple computers 1702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

Several embodiments have been described. Nevertheless, it will be understood that various modifications may be made without departing from the scope of the data processing system described herein. Accordingly, other embodiments are within the scope of the following claims.

What is claimed is:

1. A method for drilling a hydrocarbon well in a subterranean formation based on channel thicknesses, the method comprising:
receiving seismic data for the subterranean formation;
extracting values for seismic attributes from the seismic data;
executing a machine learning model trained using synthetic seismic attribute values that are associated with true values of channel thicknesses for synthetic channels, the machine learning model receiving the extracted values for the seismic attributes as input values;
generating, based on the executing, at least one predicted value of a channel thickness for a channel in the subterranean formation;
generating, based on the at least one predicted value of the channel thickness for the channel, a map of the subterranean formation including the channel.

2. The method of claim 1, further comprising:
controlling a depth of a drilling process in the channel based on the at least one predicted value of the channel thickness.

3. The method of claim 1, further comprising:
generating the synthetic seismic attribute values by performing operations comprising:
generating a geological framework for a three-dimensional (3D) geological model;
generating channel models for the synthetic channels within the geological framework;
determine P-wave velocities, S-wave velocities, and density functions for the geological model;
performing a convolution of the S-wave velocities, the P-wave velocities, and the density functions into time domain from depth domain;
generating, based on the convolution, an isotropic synthetic seismic volume; and
extracting, from the isotropic synthetic seismic volume, synthetic seismic attribute values.

4. The method of claim 1, wherein a seismic reflector for the seismic data comprises a layer of the subterranean formation that is below a base of the channel.

5. The method of claim 1, wherein the seismic attributes are selected from a group comprising: an average envelope value; a frequency filter; an average magnitude; a sum of negative amplitudes; a maximum amplitude; a general spectral decomposition; a time at minimum amplitude; an iso-frequency component at 5 Hz; a time at maximum amplitude; a general spectral decomposition at 10 Hz; a local flatness; and a channel differentiation attribute.

6. The method of claim 1, wherein the machine learning model comprises an extra trees regression model configured to generate at least 100 trees with different initialization points and select an optimal initialization point from the different initialization points.

7. The method of claim 1, further comprising:
validating the least one predicted value of the channel thickness in the subterranean formation by comparing the at least one predicted value of the channel thickness to a measured channel thickness of the channel.

8. A system for drilling a hydrocarbon well in a subterranean formation based on channel thicknesses, the system comprising:
at least one processor; and
a memory storing instructions that, when executed by the at least one processor, cause the at least one processor to perform operations comprising:
receiving seismic data for the subterranean formation;
extracting values for seismic attributes from the seismic data;
executing a machine learning model trained using synthetic seismic attribute values that are associated with true values of channel thicknesses for synthetic channels, the machine learning model receiving the extracted values for the seismic attributes as input values;
generating, based on the executing, at least one predicted value of a channel thickness for a channel in the subterranean formation;
generating, based on the at least one predicted value of the channel thickness for the channel, a map of the subterranean formation including the channel.

9. The system of claim 8, the operations further comprising:
controlling a depth of a drilling process in the channel based on the at least one predicted value of the channel thickness.

10. The system of claim 8, the operations further comprising:
generating the synthetic seismic attribute values by performing operations comprising:
generating a geological framework for a three-dimensional (3D) geological model;
generating channel models for the synthetic channels within the geological framework;
determine P-wave velocities, S-wave velocities, and density functions for the geological model;
performing a convolution of the S-wave velocities, the P-wave velocities, and the density functions into time domain from depth domain;
generating, based on the convolution, an isotropic synthetic seismic volume; and
extracting, from the isotropic synthetic seismic volume, synthetic seismic attribute values.

11. The system of claim 8, wherein a seismic reflector for the seismic data comprises a layer of the subterranean formation that is below a base of the channel.

12. The system of claim 8, wherein the seismic attributes are selected from a group comprising: an average envelope value; a frequency filter; an average magnitude; a sum of negative amplitudes; a maximum amplitude; a general spectral decomposition; a time at minimum amplitude; an iso-frequency component at 5 Hz; a time at maximum amplitude; a general spectral decomposition at 10 Hz; a local flatness; and a channel differentiation attribute.

13. The system of claim 8, wherein the machine learning model comprises an extra trees regression model configured to generate at least 100 trees with different initialization points and select an optimal initialization point from the different initialization points.

14. The system of claim 8, the operations further comprising:
validating the least one predicted value of the channel thickness in the subterranean formation by comparing the at least one predicted value of the channel thickness to a measured channel thickness of the channel.

15. One or more non-transitory computer-readable media storing instructions for drilling a hydrocarbon well in a subterranean formation based on channel thicknesses, the instructions, when executed by at least one processor, causing the at least one processor to perform operations comprising:
receiving seismic data for the subterranean formation;
extracting values for seismic attributes from the seismic data;
executing a machine learning model trained using synthetic seismic attribute values that are associated with true values of channel thicknesses for synthetic channels, the machine learning model receiving the extracted values for the seismic attributes as input values;
generating, based on the executing, at least one predicted value of a channel thickness for a channel in the subterranean formation;
generating, based on the at least one predicted value of the channel thickness for the channel, a map of the subterranean formation including the channel.

16. The one or more non-transitory computer-readable media of claim 15, the operations further comprising:
controlling a depth of a drilling process in the channel based on the at least one predicted value of the channel thickness.

17. The one or more non-transitory computer-readable media of claim 15, the operations further comprising:
generating the synthetic seismic attribute values by performing operations comprising:
generating a geological framework for a three-dimensional (3D) geological model;
generating channel models for the synthetic channels within the geological framework;
determine P-wave velocities, S-wave velocities, and density functions for the geological model;
performing a convolution of the S-wave velocities, the P-wave velocities, and the density functions into time domain from depth domain;
generating, based on the convolution, an isotropic synthetic seismic volume; and
extracting, from the isotropic synthetic seismic volume, synthetic seismic attribute values.

18. The one or more non-transitory computer-readable media of claim 15, wherein a seismic reflector for the seismic data comprises a layer of the subterranean formation that is below a base of the channel.

19. The one or more non-transitory computer-readable media of claim 15, wherein the seismic attributes are selected from a group comprising: an average envelope value; a frequency filter; an average magnitude; a sum of negative amplitudes; a maximum amplitude; a general spectral decomposition; a time at minimum amplitude; an iso-frequency component at 5 Hz; a time at maximum amplitude; a general spectral decomposition at 10 Hz; a local flatness; and a channel differentiation attribute.

20. The one or more non-transitory computer-readable media of claim 15, wherein the machine learning model comprises an extra trees regression model configured to generate at least 100 trees with different initialization points and select an optimal initialization point from the different initialization points.
